(19) United States
(12) Patent Application Publication
(10) Pub. No.: US 2025/0061277 A1
(43) Pub. Date: Feb. 20, 2025

(54) TRAINING AND USING A DEEP LEARNING MODEL FOR TRANSCRIPT TOPIC SEGMENTATION

(71) Applicants: Chenguang ZHU, Redmond, WA (US); Yang LIU, Redmond, WA (US); David HUNG, Redmond, WA (US); Nanshan ZENG, Redmond, WA (US); Microsoft Technology Licensing, LLC, Redmond, WA (US)

(72) Inventors: Chenguang ZHU, Sammamish, WA (US); Yang LIU, Nanjing, Jiangsu (CN); David Peace HUNG, Shoreline, WA (US); Nanshan ZENG, Bellevue, WA (US)

(21) Appl. No.: 18/720,606

(22) PCT Filed: Dec. 15, 2021
(86) PCT No.: PCT/CN2021/138195

§ 371 Date: Jun. 14, 2024

(51) Int. Cl. G06F 40/284; G06F 40/30; G10L 15/26

(52) U.S. Cl. CPC G06F 40/284; G06F 40/30; G10L 15/26

(57) ABSTRACT

The disclosure herein describes using a deep learning model to identify topic segments of a communication transcript. A communication transcript including a set of utterances is obtained. The set of utterances is divided into a plurality of utterance windows, wherein each utterance window of the plurality of utterance windows includes a different subset of utterances of the set of utterances, and wherein each utterance of the set of utterances is included in at least one utterance window of the plurality of utterance windows. For each utterance window of the plurality of utterance windows, each utterance in the utterance window is classified as a topic boundary or a non-boundary using a deep learning model. Topic segments of the communication transcript are identified based on utterances of the set of utterances that are classified as topic boundaries. A communication transcript summary is generated using the communication transcript and the identified topic segments.

### BACKGROUND

Modern meetings or other instances of communication between parties are often recorded so that the content of the communication can be reviewed after the communication is completed. Further, the recorded content is often analyzed, enhanced, and/or enriched to enable users to access and use the recorded content more accurately and efficiently. For instance, audio data is often analyzed such that transcript text data of the communication can be generated and enhanced with summary information and/or other metadata. However, enhancing transcripts of communications that are long and include discussions of multiple topics present significant challenges. For instance, enhancing such a transcript with a single summary often results in a summary that is too broad to be useful or a summary that fails to include at least some useful information about the transcript.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for using a deep learning model to identify topic segments of a communication transcript is described. A communication transcript including a set of utterances is obtained, wherein the obtained communication transcript is a text data set. The set of utterances is divided into a plurality of utterance windows of a defined window size, wherein each utterance window of the plurality of utterance windows includes a different subset of utterances of the set of utterances, and wherein each utterance of the set of utterances is included in at least one utterance window of the plurality of utterance windows. For each utterance window of the plurality of utterance windows, each utterance in the utterance window is classified as a topic boundary or a non-boundary using a deep learning model. Topic segments of the communication transcript are identified based on utterances of the set of utterances that are classified as topic boundaries. A communication transcript summary is generated using the communication transcript and the identified topic segments.

### BRIEF DESCRIPTION OF THE DRAWINGS

The present description will be better understood from the following detailed description read in light of the accompanying drawings, wherein:

FIG. 1 is a block diagram illustrating a system configured to divide a communication transcript into topic segments using a deep learning model;

FIGS. 2A-B are diagrams illustrating a rolling utterance window used to analyze a communication transcript;

FIG. 3 is a block diagram illustrating a system configured to train a topic boundary classifier model using deep learning techniques;

FIG. 4 is a block diagram illustrating a topic boundary classifier model configured to generate utterance boundary scores from a set of utterances of an utterance window;

FIG. 5 is a flowchart illustrating a computerized method for dividing a communication transcript into topic segments using a deep learning model;

FIG. 6 is a flowchart illustrating a computerized method for training a deep learning model to identify topic segment boundaries in communication transcripts; and

FIG. 7 illustrates an example computing apparatus as a functional block diagram.

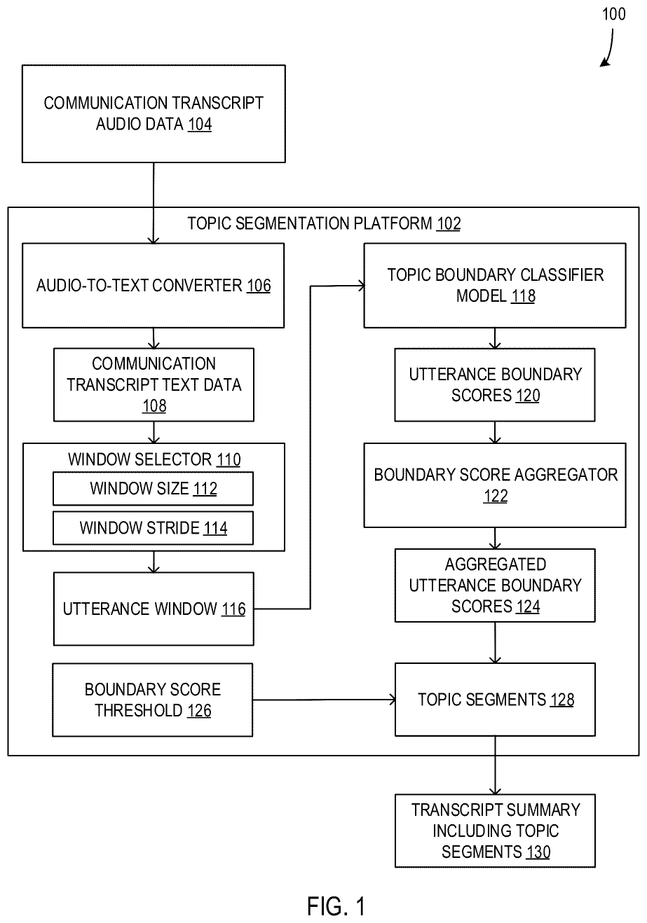

Corresponding reference characters indicate corresponding parts throughout the drawings. In FIGS. 1 to 7, the systems are illustrated as schematic drawings. The drawings may not be to scale.

### DETAILED DESCRIPTION

Aspects of the disclosure provide a computerized method and system for training a deep learning model such as a deep neural network to classify utterances as topic boundaries based on surrounding utterances and to use the trained deep learning model to identify topic segments in communication transcripts. Communication transcript text data is analyzed to identify a set of utterances therein or those utterances are identified manually. The transcript utterances are divided into utterance windows of a consistent size and each of those utterance windows is provided to the deep learning model for classification of the utterances therein. In some examples, dividing the text data into utterance windows includes selecting a first utterance window, processing it, and then sliding it along the utterances of the text data to obtain a new utterance window for analysis. The deep learning model provides boundary scores for each utterance in the text data and based on a comparison to an utterance boundary threshold value, utterances that are topic boundaries are identified. Those topic boundaries are used to identify topic segments of the text data and those topic summaries are further used to enhance the communication transcript text data, such as by generating a transcript summary that includes summary information for each topic segment.

The disclosure operates in an unconventional manner at least by using a deep learning model to classify individual utterances of the communication transcript. The deep learning model is trained to determine a probability that an utterance is a topic boundary when given a set of consecutive utterances from an utterance window. The deep learning model is pre-trained using general text training data and then it is trained using communication transcript training data as described herein.

Further, disclosure uses dynamic thresholding to avoid under-segmentation of transcripts (e.g., a transcript having topic segments that are longer than desired). The disclosure detects identified topic segments that exceed a defined length and then divides those topic segments into two separate topic segments by comparing the utterances therein to a dynamically reduced threshold value and/or by selecting the utterance therein with the highest boundary score to be updated to be a topic boundary.

Additionally, the performance of the deep learning model is improved and/or fine-tuned over time through continual training and/or self-distillation. The set of available training data is used more efficiently by first pre-training the model on a set of unlabeled communication transcripts using masked language model techniques. Then the model is fine-tuned on a labeled, or annotated, dataset to obtain a teacher model. That teacher model is used to predict “soft labels” (probability distributions of topic boundaries) on unlabeled communication transcripts and labeled communication transcripts. A student model is initialized using parameters of the teacher model and then trained using the generated soft labels, resulting in an accurate deep learning model that is more resource-efficient than the original teacher model. Using such resource-efficient models reduces the storage required for the models and/or reduces the consumption of processing and/or memory resources by the models when in use.

The disclosure enables the efficient generation of accurate topic segments in communication transcripts, enabling such transcripts to be enhanced with metadata at a topic segment level of granularity (e.g., enhanced with topic-level summary information, speaker participation data for each topic, or the like). Transcripts with the resulting topic segments can also be stored and catalogued based on the topic segments, enabling topic-based searching and/or sorting of groups of analyzed transcripts. Data analysis of such transcripts is enhanced generally by the disclosure enabling the automated generation of accurate topic segments.

Use of the described continual training of the described deep learning models enables the disclosure to be fine-tuned for use with domain-specific and/or customer-specific transcripts. The disclosed model training methods can be used by a particular customer using customer-specific transcripts as training data, such that the performance of the model used by the customer is improved with respect to the customer over time.

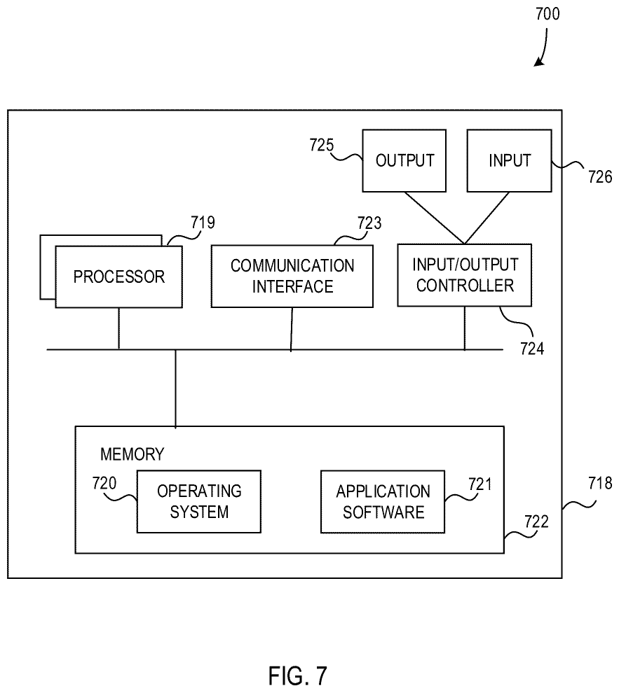

FIG. 1 is a block diagram illustrating a system 100 configured to divide a communication transcript into topic segments 128 using a deep learning model 118. The system 100 includes a topic segmentation platform 102 that is configured to receive, obtain, or otherwise get communication transcript audio data 104, to process the audio data 104, and to generate a transcript summary including topic segments 130. In some examples, the topic segmentation platform 102 includes one or more computing devices (e.g., the computing device of FIG. 7) that are configured to execute or otherwise perform operations of the topic segmentation platform 102 as described herein. In some such examples, the topic segmentation platform 102 is performed on a single computing device, but in other examples, portions of the operations of the topic segmentation platform 102 are performed on multiple computing devices that are connected to each other via a communication network (e.g., a distributed network of computing devices, cloud computing devices, or the like).

In some examples, the topic segmentation platform 102 is configured to include an audio-to-text converter 106, a window selector 110, a topic boundary classifier model 118, and a boundary score aggregator 122. The audio-to-text converter 106 is configured to convert the communication transcript audio data 104 to communication transcript text data 108. The window selector 110 is configured to select a portion of the communication transcript text data 108 as an utterance window 116 for analysis by the model 118. The topic boundary classifier model 118 is configured to analyze utterances of an utterance window 116 to generate utterance boundary scores 120. The boundary score aggregator 122 is configured to aggregate utterance boundary scores 120 (e.g., multiple scores for a single utterance) into aggregated utterance boundary scores 124 for each utterance of the communication transcript text data 108. The topic segmentation platform 102 is further configured to generate topic segments 128 based on the aggregated utterance boundary scores 124 and a defined boundary score threshold 126. Additionally, the topic segmentation platform 102 generates a transcript summary 130 based on and including the topic segments 128 as described herein.

In some examples, the communication transcript audio data 104 includes recorded audio data from a meeting or other situation where two or more people communicated with each other verbally. Alternatively, or additionally, the communication transcript audio data 104 includes recorded audio data of a single person communicating verbally (e.g., a recording of a single party on a phone call). Further, in some examples, the communication transcript audio data 104 includes multiple recorded audio streams associated with a meeting or other situation including verbal communication (e.g., recorded audio streams associated with each party to a teleconference).

Additionally, in some examples, the audio data 104 includes metadata associated with the communication within the audio data 104. For instance, metadata that identifies individual parties to the communication in association with portions of the audio data 104 (e.g., metadata indicators that identifies when particular parties are speaking in the audio data 104). Further, in some examples, other metadata is also included, such as a name or other identifier of the meeting, a time of the meeting, a place of the meeting, and/or any other context information associated with the meeting (e.g., a description of the meeting, email or other interactions that led up to the meeting, action items that result from the meeting or other results of the meeting, or the like).

The audio-to-text converter 106 includes hardware, firmware, and/or software configured to convert the communication transcript audio data 104 to the communication transcript text data 108. In some examples, the converter 106 includes a model that is trained to transcribe recorded audio of human speech into text. In such examples, the model is applied to the audio data 104 and text, including words, phrases, sentences, or the like, is generated by the model within a particular degree of accuracy (e.g., the rate at which the model transcribes a correct portion of text from a portion of the audio data 104). Further, in some examples, the converter 106 is configured to identify the speech of different parties to the communication and to include indicators in the text data 108 with respect to which party is speaking for each portion of the transcribed text (e.g., a line of text in the text data 108 starts with, ends with, or is otherwise associated with a name or other identifier of a party to the communication).

Additionally, in some examples, the converter 106 is configured to include utterance indicators in the text data 108. Such indicators define the boundaries between consecutive utterances in the text data 108, which are words or groups of words, phrases, or the like that are closely related and that occur in consecutive order. For instance, in an example, an utterance in the text data 108 includes a sentence spoken by a first party that has statements by other parties before and after it. In other examples, utterance indicators are determined based on identified pauses in the audio data 104, words and/or phrases that indicate a transition to a new utterance or the like.

Alternatively, or additionally, utterance indicators are manually added to the text data 108 by one or more users (e.g., the insertion of CLS tokens as described below). Such indicators are used by the components of the topic segmentation platform 102 throughout the other described operations to identify specific utterances in the text data 108.

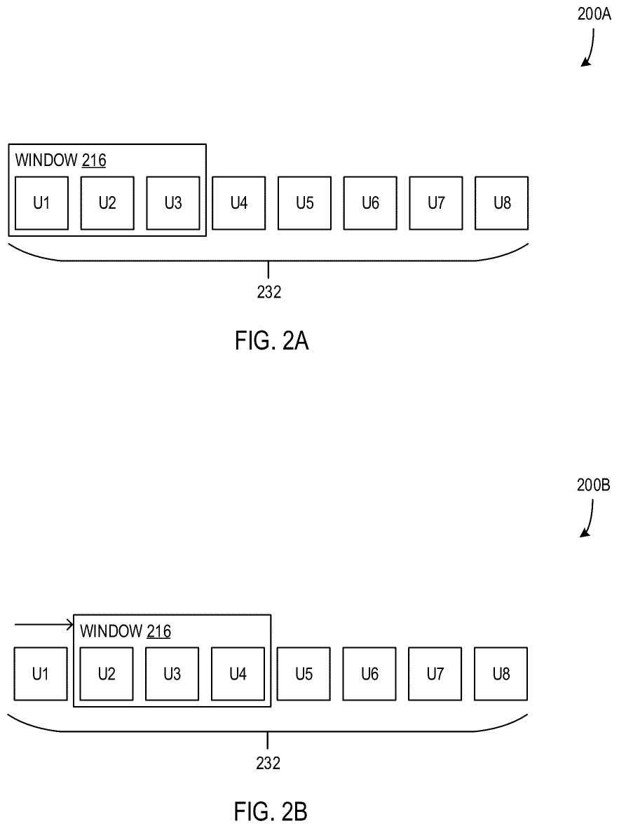

The window selector 110 includes hardware, firmware, and/or software configured to divide the text data 108 into one or more utterance windows 116 based on window size 112 and/or window stride 114. In some examples, the window selector 110 is configured to select a first utterance window 116 instance of the defined window size 112 (e.g., a set 20 consecutive utterances from the beginning of the text data 108 when the window size 112 is 20). Further, after the first utterance window 116 is analyzed using the model 118 as described herein, the window selector 110 selects a next utterance window 116 instance by sliding the first utterance window 116 instance through the text data 108 based on the window stride 114. For instance, in an example with a window size of 112, the first utterance window 116 instance includes utterances 1-20 and, based on a window stride 114 of 10, the second utterance window 116 instance includes utterances 11-30. This is illustrated in FIGS. 2A-B.

FIGS. 2A-B are diagrams illustrating a rolling utterance window 216 used to analyze a communication transcript. In FIG. 2A, a diagram 200A illustrates a series 232 of utterances U1-U8. The series 232 of utterances are consecutive utterances from communication transcript text data (e.g., the communication transcript text data 108). An utterance window 216 includes the first three utterances, U1, U2, and U3. In some examples, the utterances in the utterance window 216 are analyzed to determine the likelihood that the utterances are topic boundaries as described herein (e.g., generation of utterance boundary scores for each utterance). As illustrated, the window size 112 of the system is three utterances.

In FIG. 2B, a diagram 200B illustrates the same series 232 of utterances U1-U8. The utterance window 216 includes three utterances, U2, U3, and U4. The window 216 has shifted or slid along the series 232 by one utterance (e.g., a window stride 114 of one utterance). In some examples, the utterances in the utterance window 216 are analyzed to determine the likelihood that the utterances are topic boundaries as described herein (e.g., generation of utterance boundary scores for each utterance). The scores associated with such analysis are then aggregated with scores associated with the first window 216 instance in FIG. 2A to generate aggregated utterance boundary scores as described herein.

Returning to FIG. 1, it should be understood that, in some examples, each utterance of the text data 108 is included in more than one utterance window 116 instance such that the model 118 generates multiple utterance boundary scores 120 for each utterance. These multiple utterance boundary scores 120 motivate the inclusion of the boundary score aggregator 122 for determining aggregated utterance boundary scores 124 as described herein.

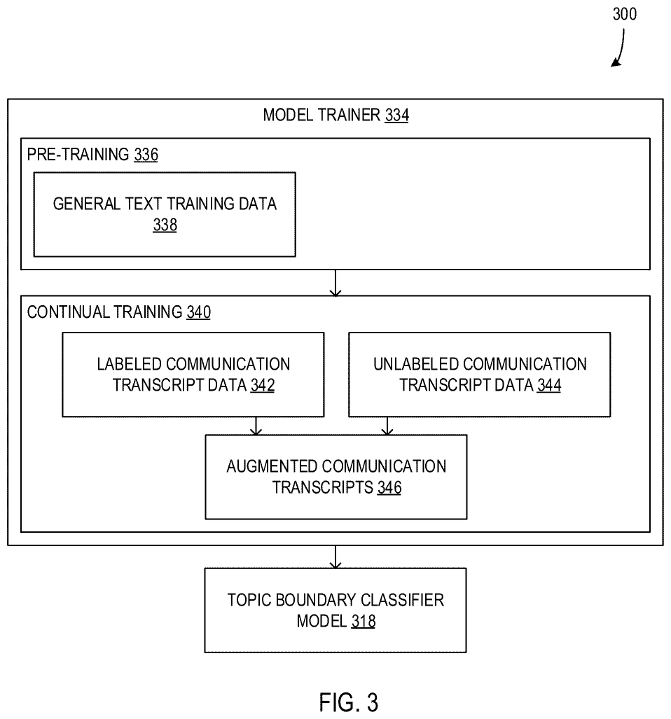

The topic boundary classifier model 118 includes hardware, firmware, and/or software configured to analyze utterance windows 116 and generate utterance boundary scores 120 for each utterance in the utterance windows 116. In some examples, the model 118 is trained using deep learning techniques. The training of the model 118 is described in greater detail below with respect to FIG. 3.

Further, in some examples, the model 118 generates utterance boundary scores 120 for each utterance of an utterance window 116 based at least in part on other utterances of the utterance window 116. For instance, in an example with an utterance window 116 that includes five utterances, the model 118 generates an utterance boundary score 120 for the third utterance of the window 116 based on that utterance and at least in part on the other four utterances of the window 116. In such examples, the model 118 is configured and trained to generate higher scores 120 for utterances that are determined to be more likely to be topic boundaries (e.g., places in the communication that the topic of conversation switches from one topic to another) and lower scores 120 for utterances that are determined to be less likely to be topic boundaries. For instance, in an example, if the words, phrases, and/or other features of the language of an utterance indicates a different topic than the prior utterance or utterances, the model 118 generates a relatively higher utterance boundary score 120 for that utterance. Alternatively, or additionally, an utterance receives a relatively higher score 120 if it includes words, phrases, or other language features that are indicative of a transition from one topic to another topic. In other examples, other patterns or indications of a change in topic are used without departing from the description.

The boundary score aggregator 122 includes hardware, firmware, and/or software configured to aggregate or otherwise combine utterance boundary scores 120 for individual utterances into single aggregated utterance boundary scores 124 for those utterances. For instance, if an utterance has three utterance boundary scores 120, the aggregator 122 is configured to combine the three utterance boundary scores 120 into a single aggregated utterance boundary score 124 for that utterance. In some examples, the boundary score aggregator 122 is configured to generate aggregated utterance boundary scores 124 by selecting a highest utterance boundary score 120 for each utterance (e.g., if an utterance has boundary scores 120 of 0.5, 0.7, and 0.3, the aggregator 122 selects the 0.7 to be the aggregated utterance boundary score 124 of the utterance). Using the highest score enables the topic segmentation platform 102 to identify many likely topic boundaries within the text data 108.

Additionally, or alternatively, the aggregator 122 is configured to aggregate multiple scores 120 into a single score 124 using different methods. For instance, in an example, the aggregator 122 is configured to average the multiple scores 120 of an utterance into a single score 124 (e.g., an utterance with scores 120 of 0.5, 0.7, and 0.3 has an aggregated utterance boundary score of 0.5 ((0.5+0.7+0.3)/3)). In other examples, other methods of aggregating boundary scores 120 are used by the aggregator 122 without departing from the description.

In some examples, the boundary score threshold 126 is defined during configuration of the topic segmentation platform 102. The threshold 126 is set at an utterance boundary score value that is indicative of the associated utterance being sufficiently likely to be a topic boundary. The topic segmentation platform 102 is configured to compare aggregated utterance boundary scores 124 of utterances of the text data 108 to the boundary score threshold 126 to generate topic segments 128. For instance, in an example, if a score 124 of an utterance exceeds the threshold 126, the utterance is used as a boundary between topic segments 128 of the text data 108.

The topic segments 128 includes data and/or metadata indicative of boundaries between utterances of the text data 108 as described herein. In some examples, a topic segment 128 includes a portion of the text data 108 that is bounded by utterances that have been identified as topic boundaries as described herein. For instance, the topic segment 128 includes a topic boundary utterance as the first utterance of its text data portion and an utterance that immediately precedes the next topic boundary utterance as the last utterance of its text data portion. Such a topic segment 128 further includes an identifier, such as a segment name, number, or code.

Alternatively, or additionally, a topic segment 128 includes an indicator of a start point of the topic segment 128 in the text data 108 and an indicator of an end point of the topic segment 128 in the text data 108. For instance, the topic segment 128 is defined by an utterance offset (e.g., a value indicating the position of an utterance within the text data based on incremented values of consecutive utterances (the first utterance has an utterance offset of ‘0’, the second utterance has an utterance offset of ‘1’, etc.)) of the start point of the segment and an utterance offset of the end point of the segment. In examples where a topic segment 128 does not include the text data specifically, the start point indicator and/or end point indicator are used with the text data 108 to access the text of the topic segment 128. In other examples, other methods of defining and accessing topic segments 128 are used without departing from the description.

In some examples, the topic segmentation platform 102 is configured to generate a transcript summary including topic segments 130. The transcript summary 130 includes indicators and/or visualizations of the topic segments 128 with respect to the text data 108. For instance, in an example, the transcript summary includes a timeline visualization of the transcript text data 108 and that timeline includes indications, such as color coding or pattern coding, of the topic segments and transitions between topic segments (e.g., the timeline is displayed as a bar and the color of the bar is changed to represent the different topic segments 128).

Further, in some examples, the topic segmentation platform 102 is configured to change the boundary score threshold 126 and/or change how the threshold 126 is applied to scores 124 in some situations. For instance, in an example, if a topic segment 128 exceeds a defined segment length threshold (e.g., a segment that is longer than 10 minutes), the platform 102 is configured use a lower threshold 126 in comparison to scores 124 of utterances in that topic segment 128. Such an adjustment serves to divide large segments 128 into multiple smaller segments 128 to enhance the granularity of the topic segments 128. Alternatively, or additionally, in an example where a topic segment 128 exceeds a defined length of time, the topic segmentation platform 102 is configured to select the utterance in that topic segment 128 that has the highest score 124 and to treat that utterance as a topic boundary for the purpose of determining topic segments 128 as described herein.

FIG. 3 is a block diagram illustrating a system 300 configured to train a topic boundary classifier model 318 using deep learning and/or other machine learning techniques. The system includes a model trainer 334 that is configured to use training data and deep learning techniques to train the topic boundary classifier model 318 as a deep neural network. In some examples, the model trainer 334 trains the model 318 using a pre-training stage 336 that uses general text training data 338 and/or a continual training stage 340 that uses training data including at least one of the following: labeled communication transcript data 342, unlabeled communication transcript data 344, and/or augmented communication transcripts 346.

In some examples, the model trainer 334 is configured to pre-train the model 318 using general text training data 338. There are large quantities of general text training data 338 that can be used to pre-train the model 318 to be able to interpret language generally (e.g., in most examples herein, the model 318 is trained using English language training data, but in other examples, other languages are used). However, in many instances, the training data 338 does not reflect the patterns and/or details of multi-party communications of the communication transcripts as described herein.

In order to complement the pre-training with the general text training data 338, the model trainer 334 trains the model 318 using labeled communication transcript data 342 and/or unlabeled communication transcript data 344. These sets of training data 342 and 344 include patterns and/or details of multi-party communications associated with the transcripts to which the model 318 will be applied (e.g., when part of a system such as system 100 of FIG. 1). In some examples, the model trainer 334 trains the model 318 with the data 342 and/or 344 using Masked Language Model (MLM) techniques. In other examples, more or different training methods are used to train the model 318 without departing from the description.

Further, in some examples, the model trainer 334 trains the model 318 using augmented communication transcripts 346. Augmented communication transcripts 346 are generated by dividing existing communication transcripts into topic segments and combining those topic segments together randomly, pseudo-randomly, or based on some other order. Topic segments from different transcripts can be combined into a single augmented communication transcript 346 and/or topic segments from a single transcript can be reordered in an augmented communication transcript 346. By using such generated transcripts 346, the quantity of available training data for training the model 318 is increased while maintaining the general patterns and/or details associated with the multi-party communications of transcripts in the target domain.

Additionally, or alternatively, training the model 318 includes more, fewer, or different techniques. For instance, in some examples, a first model 318 is trained as described above to predict topic segmentation probabilities (e.g., utterance boundary scores) for unannotated communication transcripts. When the first model 318 is trained to be accurate to an acceptable level, a student model is trained based on the output of the first model 318 (the teacher model) using self-distillation techniques. In such examples, the student model is initialized with parameters from the teacher model and the inferences of the teacher model on unannotated communication transcripts are provided to the student model as input. In some such examples, the student model is trained based on Kullback-Leibler (KL) divergence loss. The result is that the student model is trained to accurately predict topic segmentation probabilities of communication transcripts like the teacher model, but the student model occupies and/or requires fewer system resources (e.g., it takes up less data storage space).

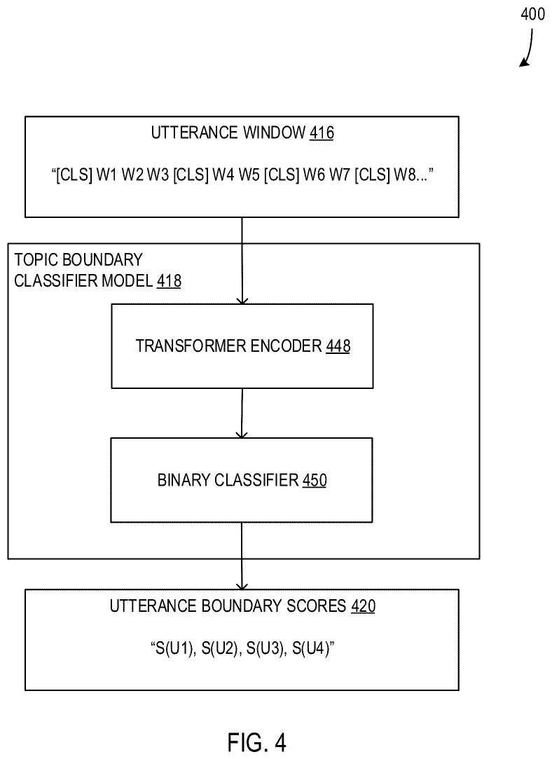

FIG. 4 is a block diagram 400 illustrating a topic boundary classifier model 418 configured to generate utterance boundary scores 420 from a set of utterances of an utterance window 416. In some examples, the topic boundary classifier model 418 is part of a system such as system 100 of FIG. 1 and has been trained by a model trainer such as model trainer 334 of system 300 of FIG. 3.

In some examples, the model 418 includes a transformer encoder 448 and a binary classifier 450. The transformer encoder 448 is configured to receive the set of utterances and to generate output vectors for each utterance with rich contextual information associated with each input utterance and associations therebetween. The output vectors of each utterance are provided to the binary classifier 450, which is configured to convert the output vectors into utterance boundary scores 420, or values that predict a likelihood that an associated utterance is a topic boundary or a first utterance of a new topic.

The utterance window 416 includes example utterances. Each utterance of the window 416 is separated using a classification symbol or token [CLS]. These tokens are inserted between words (e.g., between word W3 and word W4) manually or automatically by a model or other portion of the system, such as the audio-to-text converter 106. The [CLS] tokens are used by the topic boundary classifier model 418 to determine the boundaries of each utterance, enabling the model 418 to generate accurate output vectors and utterance boundary scores for each utterance.

The utterance boundary scores 420 include an example list of scores S(U1), S(U2), S(U3), and S(U4) that are associated with the utterances provided in the utterance window 416.

It should be understood that, in some examples, the training of the model 418 includes training the transformer encoder 448 to generate output vectors for utterances and/or training the binary classifier 450 to generate utterance boundary scores 420 based on those generated output vectors.

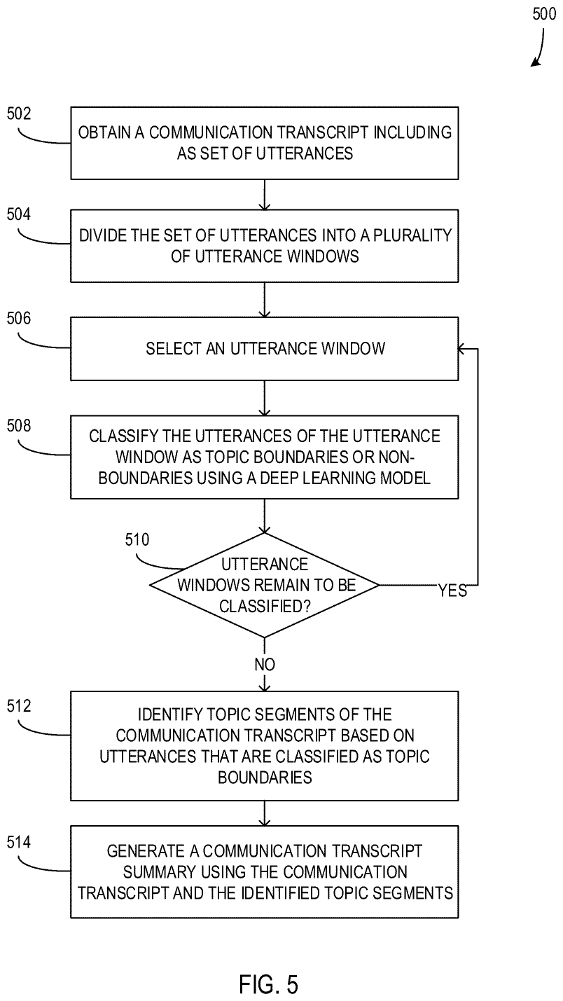

FIG. 5 is a flowchart illustrating a computerized method 500 for dividing a communication transcript into topic segments using a deep learning model. In some examples, the computerized method 500 is executed or otherwise performed by a system such as system 100 of FIG. 1. At 502, a communication transcript including a set of utterances is obtained. In some examples, the communication transcript is provided to the system and/or requested by the system. The communication transcript is a text data set. Further, in some examples, communication transcript audio data is obtained, and the audio data is converted or otherwise transformed into the text data set of the obtained communication transcript.

At 504, the set of utterances is divided into a plurality of utterance windows. In some examples, the utterance windows have a window size that represents a quantity of utterances in each utterance window. Each utterance window includes a different subset of utterances, and each utterance is included in at least one utterance window. Further, in some examples, the plurality of utterance windows includes utterance windows that overlap with each other, such that at least some utterances are included in multiple utterance windows.

Additionally, or alternatively, dividing the set of utterances into a plurality of utterance windows includes selecting a first utterance window, analyzing the selected utterance window, and sliding the selected utterance window along the set of utterances based on a window stride value (e.g., a value indicating the quantity of utterances to slide the selected utterance window along to obtain the next utterance window). After sliding the utterance window, this new utterance window is analyzed. Sliding the utterance window along the set of utterances is performed repeatedly until the complete set of utterances has been analyzed. This repeated process is reflected in 506-510 below.

At 506, an utterance window is selected and, at 508, the utterances of the selected utterance window are classified as topic boundaries or non-boundaries using a deep learning model. In some examples, the deep learning model has been trained as described herein. Further, in some examples, classifying the utterances includes calculating or otherwise determining utterance boundary scores and comparing those scores to an utterance boundary threshold. Utterances with scores that exceed the utterance boundary threshold are classified as topic boundaries and utterances with scores that do not exceed the utterance boundary threshold are classified as non-boundaries.

At 510, if one or more utterance windows remain to be classified, the process returns to 506 to select a new utterance window (e.g., sliding the utterance window to the next window position). Alternatively, if no utterance windows remain to be classified, the process proceeds to 512.

At 512, topic segments are identified in the communication transcript based on utterances that are classified as topic boundaries. In some examples, topic segments are identified by identifying each topic boundary utterance as the beginning of the next topic segment. The identified topic segments include boundary identifiers such as identifiers of the utterances that are at the beginning and the end of the topic segment and/or timestamps associated with the beginning and the end of the topic segment.

At 514, a communication transcript summary is generated using the communication transcript and the identified topic segments. In some examples, the communication transcript summary is displayed or otherwise provided to a user. Further, in some examples, the communication transcript summary includes description information associated with each topic segment that is generated from the text data of each topic segment. Additionally, or alternatively, the communication transcript summary enables a user to interact with the summary (e.g., highlighting specific topic segments, playing audio associated with specific topic segments, or the like).

In some examples, classifying the utterances of an utterance window includes generating output vectors for each utterance in the utterance window using an encoder based on the utterances of the utterance window. The generated output vectors are then analyzed using a binary classifier to classify the utterances as topic boundaries or non-boundaries.

Additionally, or alternatively, generating an utterance boundary score of an utterance includes generating a plurality of utterance boundary scores for the utterance based on a plurality of utterance windows that include the utterance. A highest utterance boundary score in the plurality of utterance boundary scores is identified, and that highest utterance boundary score is set as the utterance boundary score of the utterance.

Further, in some examples, the process includes identifying topic segments that have time lengths that exceed a segment length threshold. For each of the identified topic segments, an utterance with the highest utterance boundary score is identified and the identified utterance is classified as a topic boundary. Then, the topic segments are updated based on the newly classified topic boundaries, such that topic segments that exceed the length threshold are divided into multiple shorter topic segments.

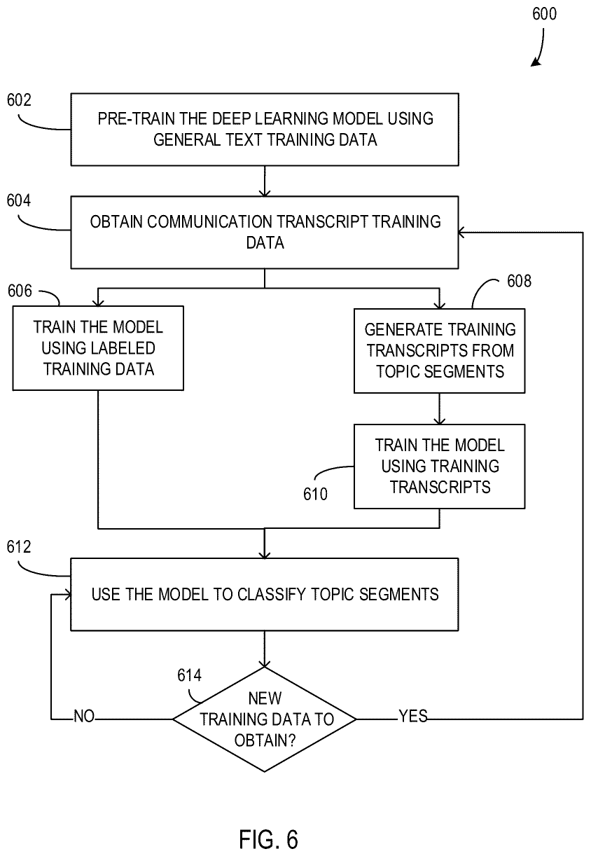

FIG. 6 is a flowchart illustrating a computerized method 600 for training a deep learning model to identify topic segment boundaries in communication transcripts. In some examples, the method 600 is executed or otherwise by performed by a system such as system 300 of FIG. 3. At 602, the deep learning model is pre-trained using general text training data.

At 604, communication transcript training data is obtained, and the model is trained using the obtained training data. Training the model using the communication transcript training data includes training the model using labeled training data at 606 and/or generating pseudo training data in the form of training transcripts (e.g., augmented communication transcripts 346 of FIG. 3) from existing topic segments at 608 and training the model using those training transcripts at 610, as described herein. In some examples, the topic segments used at 608 are obtained by using the trained model on unlabeled transcript data to identify topic segments therein. Additionally, or alternatively, topic segments from labeled transcript data are also used to generate the training transcripts. In some examples, these types of training of the model are used alone or in combination to train the deep learning model to classify utterances as topic boundaries or non-boundaries as described herein.

At 612, the trained deep learning model is used to classify topic segments as described herein.

At 614, if there is new training data to obtain, the process returns to 604 to obtain the new training data. Alternatively, if there is no new training data to obtain, the process returns to 612 for the model to continue to be used to classify topic segments. In some examples, new training data becomes available as the model classifies topic segments. An analyzed communication transcript includes topic segments that can be used as training data for the continual training of the model. For instance, a recently identified set of topic segments can be used to generate new training transcripts at 608 and those new training transcripts can be used to train the model at 610.

Further, in some examples, the training of the model includes training a teacher model according to method 600 and then training a student model using the parameters and output of the teacher model using a self-distillation method as described herein.

### Exemplary Operating Environment

The present disclosure is operable with a computing apparatus according to an embodiment as a functional block diagram 700 in FIG. 7. In an example, components of a computing apparatus 718 are implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hardcoded machine. In some examples, platform software comprising an operating system 720 or any other suitable platform software is provided on the apparatus 718 to enable application software 721 to be executed on the device. In some examples, training and using a deep learning model to identify topic segments in a communication transcript as described herein is accomplished by software, hardware, and/or firmware.

In some examples, computer executable instructions are provided using any computer-readable media that are accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises at least one processor; and at least one memory comprising computer program code, the at least one memory and the computer program code configured to, with the at least one processor, cause the at least one processor to: obtain a communication transcript including a set of utterances, wherein the obtained communication transcript is a text data set; divide the set of utterances into a plurality of utterance windows of a defined window size, wherein each utterance window of the plurality of utterance windows includes a different subset of utterances of the set of utterances, and wherein each utterance of the set of utterances is included in at least one utterance window of the plurality of utterance windows; for each utterance window of the plurality of utterance windows, classify each utterance in the utterance window as a topic boundary or a non-boundary using a deep learning model applied to the utterance window; identify topic segments of the communication transcript based on utterances of the set of utterances that are classified as topic boundaries; and generate a communication transcript summary using the communication transcript and the identified topic segments.

An example computerized method comprises obtaining, by a processor, a communication transcript including a set of utterances, wherein the obtained communication transcript is a text data set; dividing, by the processor, the set of utterances into a plurality of utterance windows of a defined window size, wherein each utterance window of the plurality of utterance windows includes a different subset of utterances of the set of utterances, and wherein each utterance of the set of utterances is included in at least one utterance window of the plurality of utterance windows; for each utterance window of the plurality of utterance windows, classifying, by the processor, each utterance in the utterance window as a topic boundary or a non-boundary using a deep learning model applied to the utterance window; identifying, by the processor, topic segments of the communication transcript based on utterances of the set of utterances that are classified as topic boundaries; and generating, by the processor, a communication transcript summary using the communication transcript and the identified topic segments.

One or more computer storage media having computer-executable instructions that, upon execution by a processor, cause the processor to at least: obtain a communication transcript including a set of utterances, wherein the obtained communication transcript is a text data set; divide the set of utterances into a plurality of utterance windows of a defined window size, wherein each utterance window of the plurality of utterance windows includes a different subset of utterances of the set of utterances, and wherein each utterance of the set of utterances is included in at least one utterance window of the plurality of utterance windows; for each utterance window of the plurality of utterance windows, classify each utterance in the utterance window as a topic boundary or a non-boundary using a deep learning model applied to the utterance window; identify topic segments of the communication transcript based on utterances of the set of utterances that are classified as topic boundaries; and generate a communication transcript summary using the communication transcript and the identified topic segments.

Alternatively, or in addition to the other examples described herein, examples include any combination of the following:
wherein classifying each utterance in the utterance window as a topic boundary or a non-boundary using a model applied to the utterance window includes: generating output vectors for each utterance in the utterance window using an encoder based on the utterances of the utterance window; and classifying the utterances of the utterance window as topic boundaries or non-boundaries using a binary classifier applied to the generated output vectors.
wherein classifying each utterance in the utterance window as a topic boundary or a non-boundary using a model applied to the utterance window includes: generating an utterance boundary score for a target utterance in the utterance window; based on the generated utterance boundary score of the target utterance in the utterance window exceeding a boundary score threshold, classifying the target utterance as a topic boundary; and based on the generated utterance boundary score of the target utterance in the utterance window not exceeding the boundary score threshold, classifying the target utterance as a non-boundary.
wherein generating an utterance boundary score for the target utterance in the utterance window further includes: generating a plurality of utterance boundary scores for the target utterance based on a plurality of utterance windows that include the target utterance; and identifying a highest utterance boundary score in the plurality of utterance boundary scores; and setting the identified highest utterance boundary score to be the utterance boundary score of the target utterance.
further comprising: pre-training the deep learning model using general text training data; and training the pre-trained deep learning model continually using communication transcript training data including at least one of the following: labeled communication transcript training data and unlabeled communication transcript training data.
wherein training the pre-trained deep learning model continually includes: identifying topic segments in communication transcript training data; organizing the identified topic segments in a plurality of different orders to form a plurality of training transcripts; and training the pre-trained deep learning model using the plurality of training transcripts.
wherein training the pre-trained deep learning model continually includes: training a teacher model using the communication transcript training data; initialize a student model with parameters of the teacher model; and train the student model with output from the teacher model using a self-distillation process, wherein the trained student model is used as the deep learning model.
further comprising: identifying a topic segment of the identified topic segments that has a time length that exceeds a segment length threshold; identifying an utterance in the identified topic segment with a highest utterance boundary score; and classifying the identified utterance as a topic boundary, wherein the identified topic segments are updated based on classifying the identified utterance as a topic boundary.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining, by a processor, a communication transcript including a set of utterances, wherein the obtained communication transcript is a text data set; exemplary means for dividing, by the processor, the set of utterances into a plurality of utterance windows of a defined window size, wherein each utterance window of the plurality of utterance windows includes a different subset of utterances of the set of utterances, and wherein each utterance of the set of utterances is included in at least one utterance window of the plurality of utterance windows; for each utterance window of the plurality of utterance windows, exemplary means for classifying, by the processor, each utterance in the utterance window as a topic boundary or a non-boundary using a deep learning model applied to the utterance window; exemplary means for identifying, by the processor, topic segments of the communication transcript based on utterances of the set of utterances that are classified as topic boundaries; and exemplary means for generating, by the processor, a communication transcript summary using the communication transcript and the identified topic segments.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
at least one processor; and
at least one memory comprising computer program code, the at least one memory and the computer program code configured to, with the at least one processor, cause the at least one processor to:
obtain a communication transcript including a set of utterances, wherein the obtained communication transcript is a text data set;
divide the set of utterances into a plurality of utterance windows of a defined window size, wherein each utterance window of the plurality of utterance windows includes a different subset of utterances of the set of utterances, and wherein each utterance of the set of utterances is included in at least one utterance window of the plurality of utterance windows;
for each utterance window of the plurality of utterance windows, classify each utterance in the utterance window as a topic boundary or a non-boundary using a deep learning model applied to the utterance window;
identify topic segments of the communication transcript based on utterances of the set of utterances that are classified as topic boundaries; and
generate a communication transcript summary using the communication transcript and the identified topic segments.

2. The system of claim 1, wherein classifying each utterance in the utterance window as a topic boundary or a non-boundary using a model applied to the utterance window includes:
generating output vectors for each utterance in the utterance window using an encoder based on the utterances of the utterance window; and
classifying the utterances of the utterance window as topic boundaries or non-boundaries using a binary classifier applied to the generated output vectors.

3. The system of claim 1, wherein classifying each utterance in the utterance window as a topic boundary or a non-boundary using a model applied to the utterance window includes:
generating an utterance boundary score for a target utterance in the utterance window;
based on the generated utterance boundary score of the target utterance in the utterance window exceeding a boundary score threshold, classifying the target utterance as a topic boundary; and
based on the generated utterance boundary score of the target utterance in the utterance window not exceeding the boundary score threshold, classifying the target utterance as a non-boundary.

4. The system of claim 3, wherein generating an utterance boundary score for the target utterance in the utterance window further includes:
generating a plurality of utterance boundary scores for the target utterance based on a plurality of utterance windows that include the target utterance; and
identifying a highest utterance boundary score in the plurality of utterance boundary scores; and
setting the identified highest utterance boundary score to be the utterance boundary score of the target utterance.

5. The system of claim 1, wherein the at least one memory and the computer program code are configured to, with the at least one processor, further cause the at least one processor to:
pre-train the deep learning model using general text training data; and
train the pre-trained deep learning model continually using communication transcript training data including at least one of the following: labeled communication transcript training data and unlabeled communication transcript training data.

6. The system of claim 5, wherein training the pre-trained deep learning model continually includes:
identifying topic segments in communication transcript training data;
organizing the identified topic segments in a plurality of different orders to form a plurality of training transcripts; and
training the pre-trained deep learning model using the plurality of training transcripts.

7. The system of claim 5, wherein training the pre-trained deep learning model continually includes:
training a teacher model using the communication transcript training data;
initialize a student model with parameters of the teacher model; and
train the student model with output from the teacher model using a self-distillation process, wherein the trained student model is used as the deep learning model.

8. The system of claim 1, wherein the at least one memory and the computer program code are configured to, with the at least one processor, further cause the at least one processor to:
identify a topic segment of the identified topic segments that has a time length that exceeds a segment length threshold;
identify an utterance in the identified topic segment with a highest utterance boundary score; and
classify the identified utterance as a topic boundary, wherein the identified topic segments are updated based on classifying the identified utterance as a topic boundary.

9. A computerized method comprising:
obtaining, by a processor, a communication transcript including a set of utterances, wherein the obtained communication transcript is a text data set;
dividing, by the processor, the set of utterances into a plurality of utterance windows of a defined window size, wherein each utterance window of the plurality of utterance windows includes a different subset of utterances of the set of utterances, and wherein each utterance of the set of utterances is included in at least one utterance window of the plurality of utterance windows;
for each utterance window of the plurality of utterance windows, classifying, by the processor, each utterance in the utterance window as a topic boundary or a non-boundary using a deep learning model applied to the utterance window;
identifying, by the processor, topic segments of the communication transcript based on utterances of the set of utterances that are classified as topic boundaries; and
generating, by the processor, a communication transcript summary using the communication transcript and the identified topic segments.

10. The computerized method of claim 9, wherein classifying each utterance in the utterance window as a topic boundary or a non-boundary using a model applied to the utterance window includes:
generating output vectors for each utterance in the utterance window using an encoder based on the utterances of the utterance window; and
classifying the utterances of the utterance window as topic boundaries or non-boundaries using a binary classifier applied to the generated output vectors.

11. The computerized method of claim 9, wherein classifying each utterance in the utterance window as a topic boundary or a non-boundary using a model applied to the utterance window includes:
generating an utterance boundary score for a target utterance in the utterance window;
based on the generated utterance boundary score of the target utterance in the utterance window exceeding a boundary score threshold, classifying the target utterance as a topic boundary; and
based on the generated utterance boundary score of the target utterance in the utterance window not exceeding the boundary score threshold, classifying the target utterance as a non-boundary.

12. The computerized method of claim 11, wherein generating an utterance boundary score for the target utterance in the utterance window further includes:
generating a plurality of utterance boundary scores for the target utterance based on a plurality of utterance windows that include the target utterance; and
identifying a highest utterance boundary score in the plurality of utterance boundary scores; and
setting the identified highest utterance boundary score to be the utterance boundary score of the target utterance.

13. The computerized method of claim 9, further comprising:
pre-training the deep learning model using general text training data; and
training the pre-trained deep learning model continually using communication transcript training data including at least one of the following: labeled communication transcript training data and unlabeled communication transcript training data.

14. The computerized method of claim 13, wherein training the pre-trained deep learning model continually includes:
identifying topic segments in communication transcript training data;
organizing the identified topic segments in a plurality of different orders to form a plurality of training transcripts; and
training the pre-trained deep learning model using the plurality of training transcripts.

15. The computerized method of claim 13, wherein training the pre-trained deep learning model continually includes:
training a teacher model using the communication transcript training data;
initialize a student model with parameters of the teacher model; and
train the student model with output from the teacher model using a self-distillation process, wherein the trained student model is used as the deep learning model.

16. The computerized method of claim 9, further comprising:
identifying a topic segment of the identified topic segments that has a time length that exceeds a segment length threshold;
identifying an utterance in the identified topic segment with a highest utterance boundary score; and
classifying the identified utterance as a topic boundary, wherein the identified topic segments are updated based on classifying the identified utterance as a topic boundary.

17. One or more computer storage media having computer-executable instructions that, upon execution by a processor, cause the processor to at least:
obtain a communication transcript including a set of utterances, wherein the obtained communication transcript is a text data set;
divide the set of utterances into a plurality of utterance windows of a defined window size, wherein each utterance window of the plurality of utterance windows includes a different subset of utterances of the set of utterances, and wherein each utterance of the set of utterances is included in at least one utterance window of the plurality of utterance windows;
for each utterance window of the plurality of utterance windows, classify each utterance in the utterance window as a topic boundary or a non-boundary using a deep learning model applied to the utterance window;
identify topic segments of the communication transcript based on utterances of the set of utterances that are classified as topic boundaries; and
generate a communication transcript summary using the communication transcript and the identified topic segments.

18. The one or more computer storage media of claim 17, wherein classifying each utterance in the utterance window as a topic boundary or a non-boundary using a model applied to the utterance window includes:
generating an utterance boundary score for a target utterance in the utterance window;
based on the generated utterance boundary score of the target utterance in the utterance window exceeding a boundary score threshold, classifying the target utterance as a topic boundary; and
based on the generated utterance boundary score of the target utterance in the utterance window not exceeding the boundary score threshold, classifying the target utterance as a non-boundary.

19. The one or more computer storage media of claim 18, wherein generating an utterance boundary score for the target utterance in the utterance window further includes:
generating a plurality of utterance boundary scores for the target utterance based on a plurality of utterance windows that include the target utterance; and
identifying a highest utterance boundary score in the plurality of utterance boundary scores; and
setting the identified highest utterance boundary score to be the utterance boundary score of the target utterance.

20. The one or more computer storage media of claim 17, wherein the computer-executable instructions, upon execution by a processor, further cause the processor to at least:
identify a topic segment of the identified topic segments that has a time length that exceeds a segment length threshold;
identify an utterance in the identified topic segment with a highest utterance boundary score; and
classify the identified utterance as a topic boundary, wherein the identified topic segments are updated based on classifying the identified utterance as a topic boundary.
